(19) United States
(12) Patent Application Publication
(10) Pub. No.: US 2018/0335907 A1
(43) Pub. Date: Nov. 22, 2018

(54) EXTENSIBLE GRAPHICAL EDITOR FOR ASSET MODELING

(71) Applicant: General Electric Company, Schenectady, NY (US)

(72) Inventor: Ganesh MOHAN, Bangalore (IN)

(21) Appl. No.: 15/600,943

(22) Filed: May 22, 2017

(51) Int. Cl. G06F 3/0484; G06F 17/50; G06F 3/0482

(52) U.S. Cl. CPC G06F 3/0484; G06F 3/0482; G06F 17/50

(57) ABSTRACT

Provided are a system and method for configuring a graphical editor interface for generating asset models of physical assets. The graphical editor may also be used to convert a format of an asset model from one format to another format with a simple request from a user or even automatically. In one example, the method includes receiving asset model configuration information corresponding to a physical asset, configuring the graphical editor interface based on the asset model configuration information, the graphical editor interface including an editor and a palette that includes elements capable of being added to the editor to build asset models, wherein the elements in the palette are dynamically populated based on attributes included in the asset model configuration information, and displaying the graphical editor interface via a display.

### BACKGROUND

Machine and equipment assets, generally, are engineered to perform particular tasks as part of a business process. For example, assets can include, among other things and without limitation, industrial manufacturing equipment on a production line, drilling equipment for use in mining operations, wind turbines that generate electricity on a wind farm, transportation vehicles, and the like. As another example, assets may include devices that aid in diagnosing patients such as imaging devices (e.g., X-ray or MRI systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the rise of inexpensive cloud computing, increasing sensor capabilities, and decreasing sensor costs, as well as the proliferation of mobile technologies have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

Industrial applications such as analytics are typically designed to work with data from or about a particular asset or group of assets. For example, an analytical application may analyze data about an asset such as an aircraft, an oil rig, a wind turbine, a healthcare machine, a locomotive, mining equipment, and the like, based on data acquired from these assets. In order to apply real-world data to the virtual world of computers, a digital representation of a physical asset may be generated and used by an industrial application. The digital representation of a physical asset (e.g., asset model) is a computerized version of the physical asset that can be used to monitor, diagnose, and predict information related thereto. However, at present there does not exist a standard schema for asset modeling. Instead, most organizations rely on their own software or third party software that has been customized and tailored to suit the individual organizations needs. As a result, an asset model is only usable within a particular domain in which it is developed.

### SUMMARY

Embodiments described herein improve upon the prior art by providing an extensible graphical editor interface that enables a developer to construct a virtual representation of a physical asset using any desired asset modeling program or software. The graphical editor interface may also be used to convert an asset model from one format to another. In some aspects, the graphical editor interface can be implemented as a service that is deployed on a cloud platform such as an Industrial Internet of Things (IIoT) and that is capable of being accessed via a web browser.

In an aspect of an example embodiment, provided is a computing system that includes a network interface configured to receive asset model configuration information corresponding to a physical asset, a processor configured to configure a graphical editor interface based on the asset model configuration information, the graphical editor interface including an editor for developing asset models and a palette that includes elements capable of being added to the editor to build asset models, wherein the elements in the palette are dynamically populated based on attributes included in the asset model configuration information, and an output configured to output the graphical editor interface to a display.

In an aspect of another example embodiment, provided is a method that includes receiving asset model configuration information corresponding to a physical asset, configuring a graphical editor interface based on the asset model configuration information, the graphical editor interface including an editor for developing asset models and a palette that includes elements capable of being added to the editor to build asset models, wherein the elements in the palette are dynamically populated based on attributes included in the asset model configuration information, and displaying the graphical editor interface via a display.

In an aspect of another example embodiment, provided is a non-transitory computer readable medium having stored therein instructions that when executed cause a computer to perform a method including receiving asset model configuration information corresponding to a physical asset, configuring a graphical editor interface based on the asset model configuration information, the graphical editor interface including an editor for developing asset models and a palette that includes elements capable of being added to the editor to build asset models, wherein the elements in the palette are dynamically populated based on attributes included in the asset model configuration information, and displaying the graphical editor interface via a display.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings, in which:

FIG. 1 is a diagram illustrating a computing environment for providing a graphical editor interface in accordance with an example embodiment.

FIG. 2A is a diagram illustrating an example of asset model information in accordance with an example embodiment.

FIG. 2B is a diagram illustrating an example of asset model configuration information in accordance with an example embodiment.

FIG. 3 is a diagram illustrating a graphical editor interface in accordance with an example embodiment.

FIG. 4 is a diagram illustrating a method of configuring a graphical editor interface in accordance with an example embodiment.

FIG. 5 is a diagram illustrating a computing device for configuring a graphical editor interface in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

According to various embodiments, provided is a graphical editor for generating digital representations of physical assets. The digital representation (also referred to as a digital twin, virtual asset, asset model, etc.) is a computerized version of a physical asset such as a machine or equipment used in industry, manufacture, healthcare, energy, transportation, and the like. For example, the asset model may be a digital representation of a real-world asset such as a wind turbine, a locomotive, an oil rig, mining equipment, a medical imaging machine (X-ray, CT, MRI, ultrasound, etc.), manufacturing equipment, and the like. The graphical editor may be interacted with by a user to generate a virtual design of an asset model. In implementation, the graphical editor may be a web service that is deployed as an extensible service accessible to users via a cloud platform. To use the graphical editor in this example, a user may access the graphical editor via a web browser, login through the service, define an asset model graphically using any desired schema, and save the graphical project. Furthermore, the graphical editor enables the developer to convert the asset model from one format to another thus making the asset model compatible with any third party software.

Asset modeling can be critical for industrial applications. A developer may create a digital model of an asset that defines properties of the asset and relationships with other assets. An example of an asset model is a logical structure of turbines on a wind farm. The developer may create instances of the asset model to represent individual turbines. At present, different industries use custom formats (also referred to herein as schemas) to define data attributes of an asset model. The formats may be based on or provided by graphical editing software that is used to generate the individual digital models or it may be custom designed. For example, an organization may use a schema of as a modeling software that is included within an asset performance management (APM) software suite, a graphical editor that is custom designed by the organization, and/or the like.

As mentioned, the graphical editor may be implemented as a service (e.g., software as a service) that is hosted by a cloud platform computing environment, for example, an Internet of Things (IoT) or an Industrial Internet of Things (IIoT) based platform. While progress with machine and equipment automation has been made over the last several decades, and assets have become ‘smarter,’ the intelligence of any individual asset pales in comparison to intelligence that can be gained when multiple smart devices are connected together, for example, in the cloud. Assets, as described herein, may refer to equipment and machines used in fields such as energy, healthcare, transportation, heavy manufacturing, chemical production, printing and publishing, electronics, textiles, and the like. Meanwhile, asset models refer to a digital representation of the physical asset. Aggregating data collected from or about multiple assets can enable users to improve business processes, for example by improving effectiveness of asset maintenance or improving operational performance if appropriate industrial-specific data collection and modeling technology is developed and applied.

For example, a physical asset can be outfitted with one or more sensors configured to monitor respective operations or conditions. Data from the sensors can be recorded or transmitted to the cloud-based or other remote computing environment described herein. By bringing such data into a cloud-based computing environment, new software applications informed by industrial process, tools and know-how can be constructed, and new physics-based analytics specific to an industrial environment can be created. Insights gained through analysis of such data can lead to enhanced asset designs, enhanced software algorithms for operating the same or similar assets, better operating efficiency, and the like.

The Predix™ platform available from GE is a novel embodiment of an Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of assets can be uniquely situated to leverage its understanding of assets themselves, models of such assets, and industrial operations or applications of such assets, to create new value for industrial customers through asset insights. One of the primary tools for creating a better understanding of these assets is analytics. Many analytics rely on virtual models of physical assets in order to perform monitoring, analytics, prognostications, and the like, associated with the physical assets.

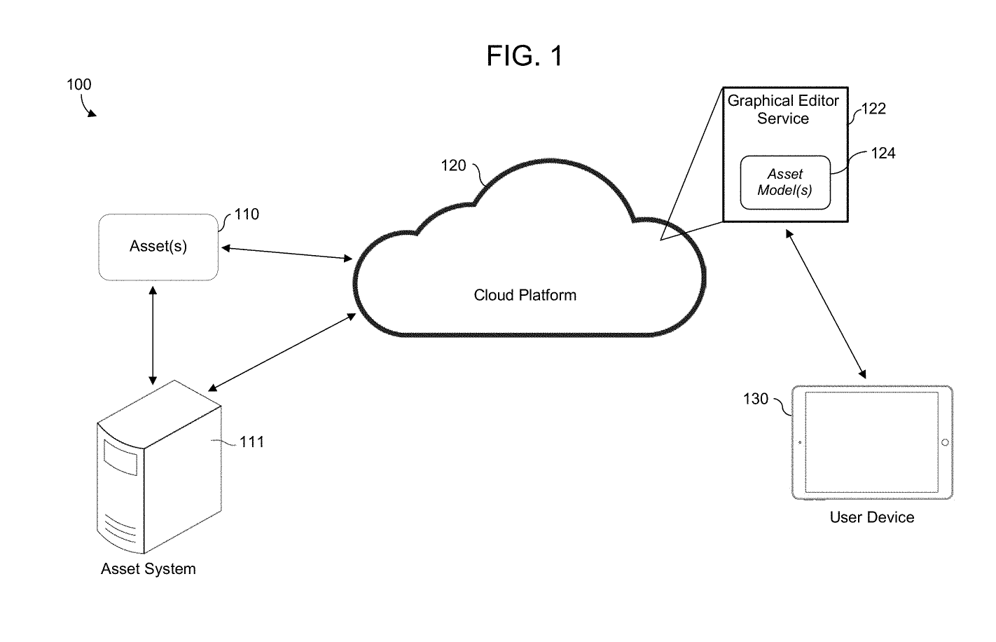

FIG. 1 illustrates a cloud computing system 100 for providing a graphical editor interface in accordance with an example embodiment. The cloud computing environment 100 includes one or more assets 110, an asset system 111, a cloud platform 120, and a user device 130. In this example, the assets 110 may be physical structures or physical assets such as wind turbines, aircraft, oil rigs, mining equipment, healthcare equipment and systems, and the like. There is no limit to the assets that may be included within the cloud computing system 100. The asset 110 may include one or more assets that emit time-series data. The raw sensor or machine data may be emitted from the asset 110 directly to the cloud platform 120 or sensed by the asset computing system 111 and provided to the cloud platform 120 in a stream, a feed, a file such as an Extensible Markup Language (XML) file, and the like. The data provided from the asset 110 may be converted into a rolled-up format that is more suitable for further processing, display, and analysis by applications and services deployed on the cloud platform.

The sensed data such as time-series data and other information provided by the asset 110 and/or the asset system 111 may be used to construct digital asset models. For example, sensor data may provide information about a shape, a size, a structure, a location, and the like, of a physical asset. This information may be used to generate a corresponding asset model that mirrors the physical asset in virtual space. In order to generate the asset model, a user of the user device 130 may interact with a graphical editor service 122 deployed on the cloud platform 120. The graphical editor service 122 may be compatible with any type of asset modeling format or software. In order to use the graphical editing service 122, the user device 130 may import or otherwise provide asset model configuration information to the graphical editor service 122 deployed on the cloud platform 120.

According to various embodiments, the asset model configuration information may be an asset model schema that includes information about the asset model such as attributes, properties, types, data structures, and the like. Based on the asset model configuration information, the graphical editing service 122 may display a graphical editor interface on the user device 130 that is based on the asset model configuration information provided by the user device 130. In other words, the asset configuration information may cause the graphical editing service 122 to come alive. Asset models may be designed using various schemas (also referred to as formats) some of which are based on third party software and others are based on custom designs. Examples of asset modeling formats include S95 editor, plain CSV, CCOM, and the like. However, it should be appreciated that the asset modeling schemas may be any format and are not limited to any particular type of format.

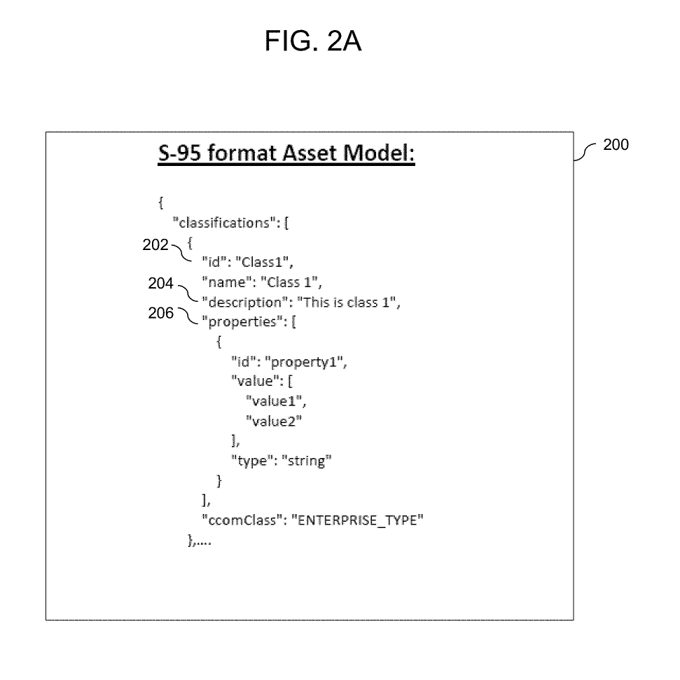

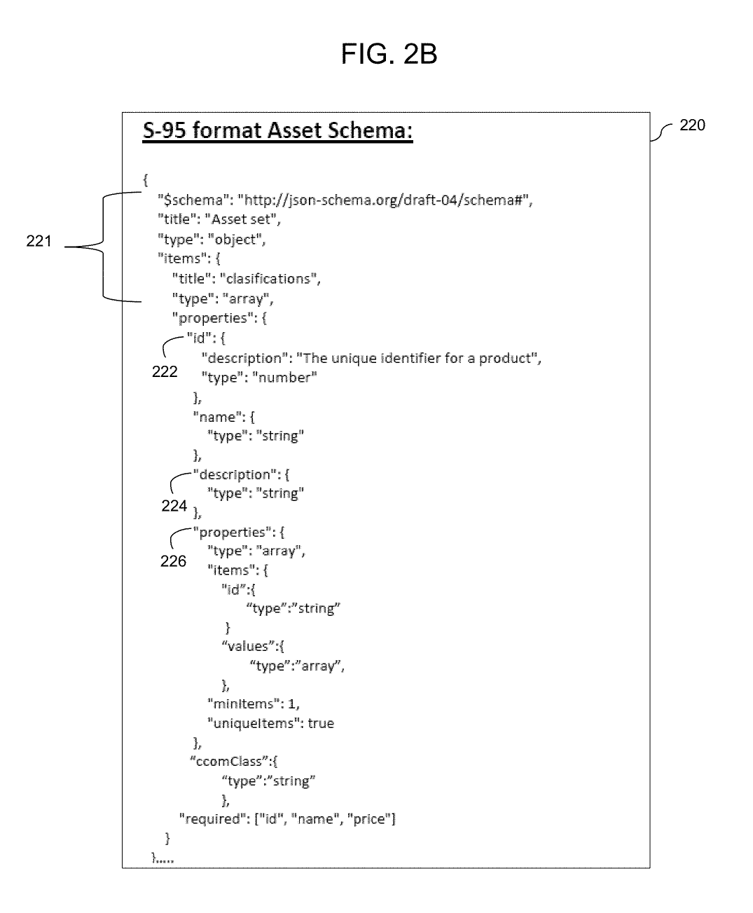

In order to configure the graphical editing interface, the graphical editor service 122 must be able to read and understand the asset configuration information. Accordingly, the user of the user device 130 may convert the asset model schema information into a common form or schema that is understandable to the graphical editor service 122 but that still retains a description of the individual attributes of the respective asset model schema. An example of converting asset modeling information into a common schema is described in the examples of FIGS. 2A and 2B. As an example, asset model configuration information may be generated based on a JavaScript Object Notation (JSON) asset model schema, however, the embodiments are not limited thereto.

Developers can create asset model schemas that define the properties of an asset model, relationship between other asset models, a structure of the asset model, and the like. For example, an asset model schema could include a logical component structure of a physical asset. Furthermore, different industries use custom schemas to define their asset models. However, there is no one uniform schema used by all industries. Furthermore, it is not possible to create an asset model in a first schema, and transfer that asset model into another schema. Furthermore, different asset model schemas may not solve or can become very complex for different industrial needs.

The graphical editing service 122 solves these issues by creating a unified interface that can operate based on different asset modeling schemas within the same interface. A user can provide normalized asset modeling configuration information to the graphical editing service 122. Based on this configuration information, the graphical editing service 122 can configure an editing interface for building virtual asset models 124 using a respective asset modeling schema including asset types, asset components, and the like, for a particular asset schema. Accordingly, the editing interface can be configured to work with different asset modeling schemas based on the configuration information that is provided to the graphical editing service 122. Furthermore, based on the asset modeling configuration information and/or asset model mapping information, the graphical editing service 122 may convert an asset model 124 having a first asset model format into a second asset model format that is different from the first asset model format.

According to various aspects, a user of the user device 130 may access the graphical editing service 122 via a web browser client executing on the user device 130. The user may provide asset model configuration information (e.g., normalized/generic information) associated with an asset modeling format to the graphical editing service 122. For example, the asset model configuration information may be provided as a JSON schema and may include various attributes and other information of the asset model format. Based on the provided asset model configuration information, the graphical editing service 122 may display a graphical editor interface and configure a palette of the graphical editor interface with various elements that correspond to the asset model format, and output the graphical editor interface to the user device 130. Here, the palette may be dynamically populated based on the components or elements included in the asset model configuration information. The user may create a new asset model via the graphical editor interface, save the asset model, and convert the asset model to different schemas via the user device 130 while using the graphical editing service 122 deployed on the cloud platform 120.

FIG. 2A illustrates an example of asset model information and FIG. 2B illustrates an example of asset model configuration information that is based on the asset model information of FIG. 2A. As shown in FIG. 2A, a format 200 of an asset model, also referred to as a schema, is included within the asset model information 200. The format 200 includes an identification (ID) 202 of the asset model, a description 204 of the asset model, and properties 206 of the asset model which include data structures and data types. It should be appreciated that the asset model information included in the format 200 is not limited to what is shown in the example of FIG. 2A, but include any other asset model information known.

Meanwhile, FIG. 2B illustrates a format of an asset model that has been converted into a common schema 220 and that can be used for configuring the graphical editor interface described herein. In this example, the common schema 220 is a JSON schema, however, the embodiments are not limited thereto. Here, the JSON schema includes attributes of the asset model included in the format 200 shown in FIG. 2A. That is, the common schema 220 of the asset model shown in FIG. 2B retains various properties of the format 200 of the asset model in FIG. 2A after conversion. In this example, the common schema 220 includes normalization information 221 for converting the data to a common schema, as well as an identification 222 of the asset model, a description 224 of the asset model, and properties 226 of the asset model. In some cases, the normalization information 221 may be included throughout a data structure of the common schema 220. The common schema 220 may be asset model configuration information that is imported to the graphical editor service described herein.

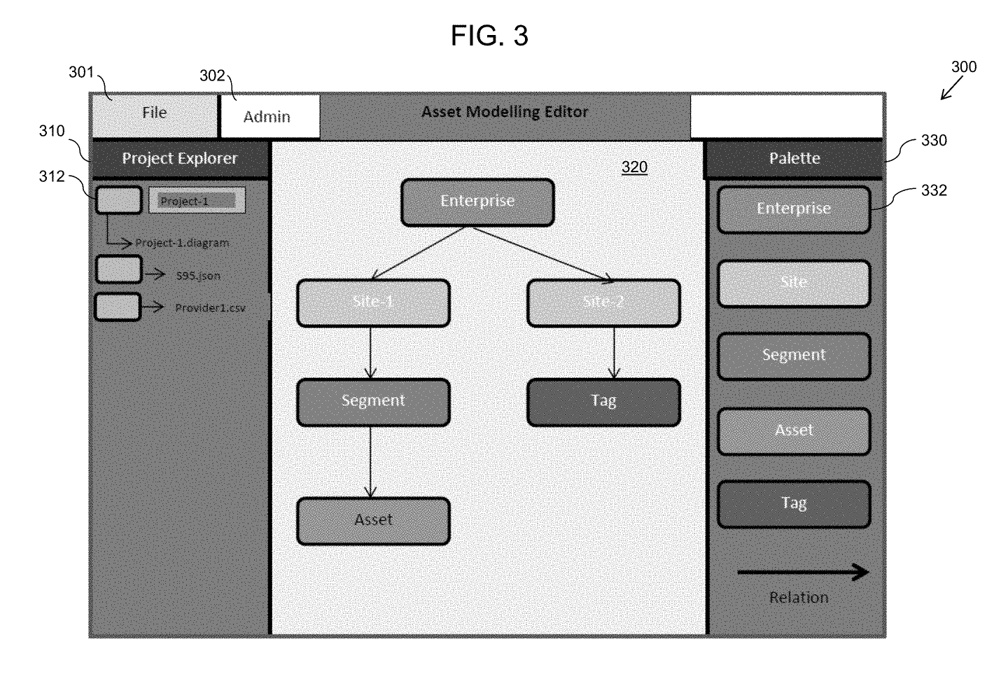

FIG. 3 illustrates a graphical editor interface 300 (i.e., interface 300) in accordance with an example embodiment. In this example, the graphical editor interface 300 includes a command bar with a file tab 301 and an admin tab 302. The interface 300 also includes a project explorer tab 310, an asset modeling editor 320, and a palette 330. The interface 300 may be implemented as a web service such as a software as a service (SaaS) that is deployed on the cloud platform and accessible to subscribers via a web browser of a client/user device. During an initial sign on, or after the interface 300 has been opened, the user may import a common schema via a file, via user input into a field or format of the web-based interface, or the like. For example, the common schema may be used to represent various asset model formats in a common schema such as a JSON schema which may be understood by the graphical editor interface 300.

In this example, the file menu 301 enables users the ability to access the project explorer 310 and the admin section 302. The file menu 301 enables a user to save an asset model graphical project, export from one asset model format to another asset model format, create a new graphical editor based on available asset models, and the like. Using the Admin section 302, user may import an asset model schema and generate an online editor based on that schema. The project explorer 310 provides a menu of available projects and also an indication of an asset model format type of the available projects.

Initially, the asset modeling editor 320 may be empty or blank and may be based on a user input (e.g., point and click, dragging and dropping, etc.) elements 332 from the palette 330 into the window of the asset modeling editor 320. The elements 332 included in the palette 330 may be used to build a new asset model project within asset modeling editor 320. According to various embodiments, the elements 332 available within palette 330 may be dynamically populated based on the attributes of an asset model included in common schema information that is imported to the interface 300 by the user. In this example, the palette 330 includes elements for configuring an asset model such as an enterprise, a site, a segment, a tag, an asset, etc. Furthermore, the interface 300 may convert an asset model from one format to another format via a button included within admin section 302 or somewhere else within the interface 300. That is, while the interface 300 allows a user to quickly build dynamic asset models, the interface 300 also allows a user to automatically convert an asset model from one format to another.

For example, an industrial asset model can be represented using a graph with the following model elements, a node, relationships, and properties. There are several third party asset performance management software's which are used by industries today. Each of this software provides various capabilities through KPI's (Key performance indicators) which are exposed using their API's. The KPI's are derived by applying appropriate analytics on the operational data obtained from an asset. The primary requirement for any APM software is defining the asset model. Today's software development encourages developers to integrate with existing system and build working software quickly. Hence, there is need for industrial companies to integrate with third party software vendors to get access to the various KPI's which defines the performance of an asset. In order, to integrate with the 3rd party software, there is a need to define an asset model in a standard which is recommended by the third party vendor. The information needed for the common asset schema described herein may be obtained from the software based on the API's and/or KPI's thereof. Furthermore, an adaptor may be used to transform an asset model from a specific format to a more generic format which clearly identifies the above properties. Later, this generic model can be used to define vendor specific asset models in another format. Such transformation may include mapping information that is stored in associated with the interface 300 or in a separate external database or data store.

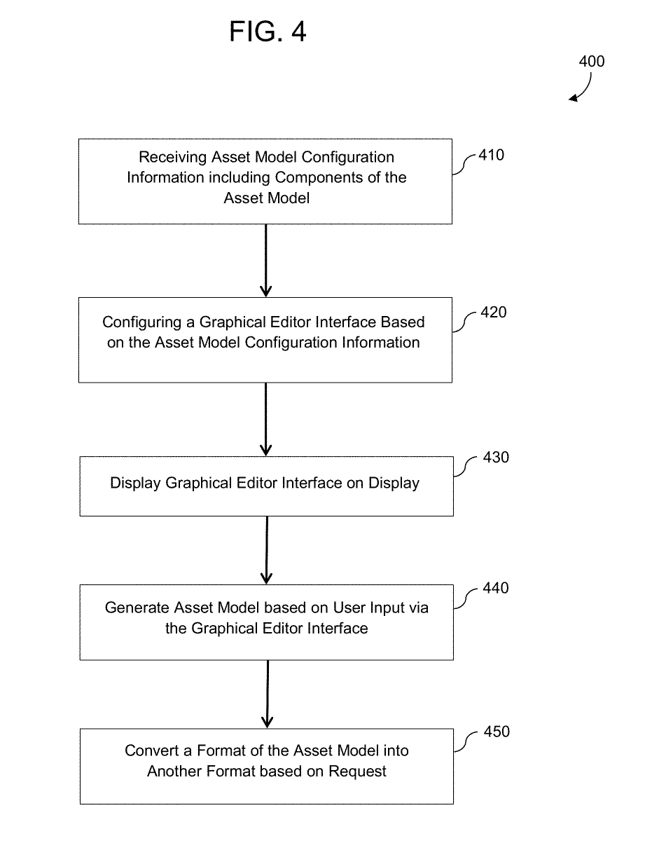

FIG. 4 illustrates a method 400 for configuring a graphical editor interface in accordance with an example embodiment. For example, the method 400 may be performed by the graphical editor service 122 deployed on the cloud platform 120 shown in FIG. 1 or it may be performed by a different device or combination of devices. Referring to FIG. 4, in 410, the method includes receiving asset model configuration information corresponding to a physical asset. The asset model configuration information may be normalized into a common schema before it is received such that it is capable of being read and understood by the service. The asset model configuration information may include a schema the describes a type of the asset model, a relationship of the asset model with respect to one or more other asset model types, and a data structure of the asset model such as properties and other components.

In 420, the method includes configuring a graphical editor interface based on the asset model configuration information. According to various embodiments, the graphical editor interface may include an editor window for developing and editing asset models and a palette that includes elements capable of being added to the editor to build asset models. The editor may include a window in which asset models are designed hierarchically based on elements from the palette. Further, the elements in the palette may be dynamically populated based on attributes included in the asset model configuration information. For example, the method may dynamically populate the palette with a first set of elements in response to the asset model configuration information including a first asset model format, and dynamically populate the palette with a different set of elements in response to the asset schema configuration information including a second model format that is different from the first model format. In 430, the method further includes displaying the graphical editor interface via a display.

In some embodiments, the method may further including generating an asset model based on user input via the graphical editor interface and storing the generated asset model in a first asset model format, in 440. In this example, the user input may include actions taken by the user to add elements from the palette to an asset model being designed via the editor.

In 450, the method also includes converting a format of the generated asset model from the first asset model format to a second asset model format that is different than the first asset model format, in response to another user input. For example, the format or the schema of the asset model may be converted based on a user pressing a button or automatically based on a condition being satisfied. To perform the converting, the service may refer to asset schema mapping information stored in a storage device associated with the graphical editor interface.

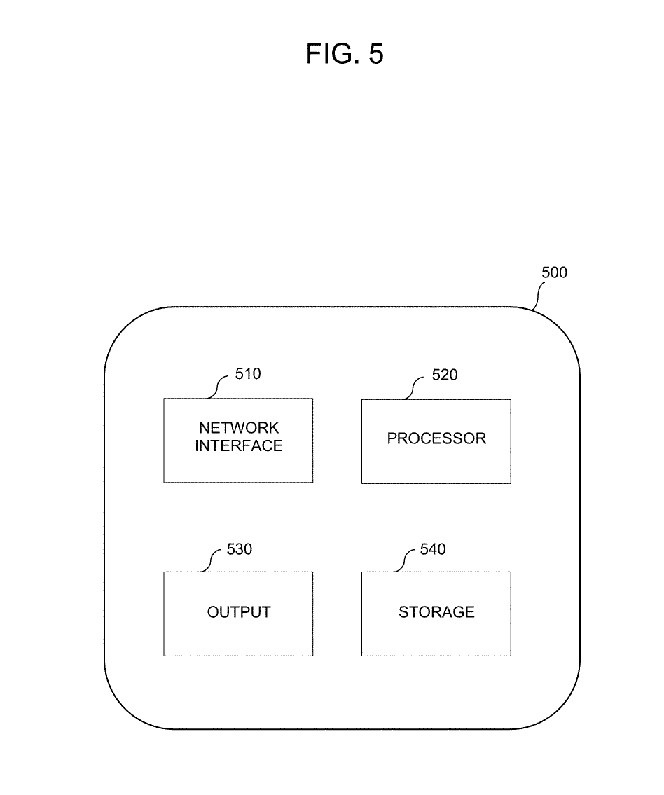

FIG. 5 illustrates a computing device 500 for configuring a graphical editor interface in accordance with an example embodiment. For example, the device 500 may be a cloud computing system, a server, a user device, and the like. Also, the device 500 may perform the method of FIG. 4. Referring to FIG. 5, the device 500 includes a network interface 510, a processor 520, an output 530, and a storage device 540. Although not shown in FIG. 5, the device 500 may include other components such as a display, an input unit, a receiver/transmitter, and the like. The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the device 500, an externally connected display, a cloud, another device, and the like. The storage device 540 is not limited to any particular storage device and may include any known memory device such as RAM, ROM, hard disk, and the like.

According to various embodiments, the network interface 510 may receive asset model configuration information corresponding to a physical asset. The processor 520 may configure a graphical editor interface based on the asset model configuration information. For example, the processor 520 may output the graphical editor interface based on an asset model schema. Here, the interface may include an editor for developing asset models and a palette that includes elements capable of being added to the editor to build asset models, wherein the elements in the palette are dynamically populated based on attributes included in the asset model configuration information. The output 530 may output the graphical editor interface to a display such as a display of a local device, or in the example of a server or cloud system, to a display of a user device accessing the cloud or the server. The processor 520 may also be able to detect user input that is received via the display of the user device and perform actions corresponding thereto to build an asset model, edit a previously built asset model, convert an asset model, and the like.

The common schema may retain attributes of a schema of the asset model but also be normalized for use by the service described herein. The schema information included in the configuration information may include one or more of a type of the asset model, a relationship of the asset model with respect to one or more other asset types, and a data structure of the asset model. Also, the elements in the palette may be dynamically populated based on components included within the common schema. Elements from the palette may be used to construct an asset model within the editor. For example, the editor may include a window in which asset models are designed hierarchically based on elements added to the window from the palette.

In some embodiments, the processor 520 may dynamically populate the palette with a first set of elements in response to the asset model configuration information including a first asset model format, and dynamically populate the palette with a different set of elements in response to the asset schema configuration information comprising a second model format that is different from the first model format. Also, the processor 520 may generate an asset model based on user input via the graphical editor interface and store the generated asset model in the storage device 540 based on a first asset model format. For example, the processor 520 may convert a format of the generated asset model from the first asset model format to a second asset model format that is different than the first asset model format, in response to another user input. In some examples, the processor 520 may convert the format of the generated asset model based on asset schema mapping information stored in the storage device that is associated with the graphical editor interface.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a network interface configured to receive asset model configuration information corresponding to a physical asset;
a processor configured to configure a graphical editor interface based on the asset model configuration information, the graphical editor interface comprising an editor for developing asset models and a palette that includes elements capable of being added to the editor to build asset models, wherein the elements in the palette are dynamically populated based on attributes included in the asset model configuration information; and
an output configured to output the graphical editor interface to a display.

2. The computing system of claim 1, wherein the asset model configuration information comprises a schema that describes the asset model, and the elements in the palette are dynamically populated based on components included within the schema.

3. The computing system of claim 2, wherein the schema comprises one or more of a type of the asset model, a relationship of the asset model with respect to one or more other asset types, and a data structure of the asset model.

4. The computing system of claim 1, wherein the editor comprises a window in which asset models are designed hierarchically based on elements from the palette.

5. The computing system of claim 1, wherein the processor is configured to dynamically populate the palette with a first set of elements in response to the asset model configuration information comprising a first asset model format, and dynamically populate the palette with a different set of elements in response to the asset schema configuration information comprising a second model format that is different from the first model format.

6. The computing system of claim 1, wherein the processor is further configured to generate an asset model based on user input via the graphical editor interface and store the generated asset model in a storage device based on a first asset model format.

7. The computing system of claim 6, wherein the processor is further configured to convert a format of the generated asset model from the first asset model format to a second asset model format that is different than the first asset model format, in response to another user input.

8. The computing system of claim 7, wherein the processor converts the format of the generated asset model based on asset schema mapping information stored in the storage device that is associated with the graphical editor interface.

9. A method comprising:
receiving asset model configuration information corresponding to a physical asset;
configuring a graphical editor interface based on the asset model configuration information, the graphical editor interface comprising an editor for developing asset models and a palette that includes elements capable of being added to the editor to build asset models, wherein the elements in the palette are dynamically populated based on attributes included in the asset model configuration information; and
displaying the graphical editor interface via a display.

10. The method of claim 9, wherein the asset model configuration information comprises a schema that describes the asset model, and the elements in the palette are dynamically populated based on components included within the schema.

11. The method of claim 10, wherein the schema comprises one or more of a type of the asset model, a relationship of the asset model with respect to one or more other asset types, and a data structure of the asset model.

12. The method of claim 9, wherein the editor comprises a window in which asset models are designed hierarchically based on elements from the palette.

13. The method of claim 9, wherein the configuring comprises dynamically populating the palette with a first set of elements in response to the asset model configuration information comprising a first asset model format, and dynamically populating the palette with a different set of elements in response to the asset schema configuration information comprising a second model format that is different from the first model format.

14. The method of claim 9, further comprising generating an asset model based on user input via the graphical editor interface and storing the generated asset model in a first asset model format.

15. The method of claim 14, further comprising converting a format of the generated asset model from the first asset model format to a second asset model format that is different than the first asset model format, in response to another user input.

16. The method of claim 15, wherein the converting comprises converting the format of the generated asset model based on asset schema mapping information stored in a storage device associated with the graphical editor interface.

17. A non-transitory computer readable medium having stored therein instructions that when executed cause a computer to perform a method comprising:
receiving asset model configuration information corresponding to a physical asset;
configuring a graphical editor interface based on the asset model configuration information, the graphical editor interface comprising an editor for developing asset models and a palette that includes elements capable of being added to the editor to build asset models, wherein the elements in the palette are dynamically populated based on attributes included in the asset model configuration information; and
displaying the graphical editor interface via a display.

18. The non-transitory computer readable medium of claim 17, wherein the asset model configuration information comprises a schema that describes the asset model, and the elements in the palette are dynamically populated based on components included within the schema.

19. The non-transitory computer readable medium of claim 18, wherein the schema comprises one or more of a type of the asset model, a relationship of the asset model with respect to one or more other asset types, and a data structure of the asset model.

20. The non-transitory computer readable medium of claim 17, wherein the configuring comprises dynamically populating the palette with a first set of elements in response to the asset model configuration information comprising a first asset model format, and dynamically populating the palette with a different set of elements in response to the asset schema configuration information comprising a second model format that is different from the first model format.
